(19) United States
(12) Patent Application Publication
(10) Pub. No.: US 2006/0279421 A1
(43) Pub. Date: Dec. 14, 2006

(54) Tracking system and method

(76) Inventors: John R. French, San Diego, CA (US); Joseph F. Nebolon, Del Mar, CA (US)

Correspondence Address: NYDEGGER & ASSOCIATES, 348 OLIVE STREET, SAN DIEGO, CA, 92103, US

(21) Appl. No.: 11/445,453

(22) Filed: Jun. 1, 2006

Related U.S. Application Data
(60) Provisional application No. 60/687,066, filed on Jun. 2, 2005.

(51) Int. Cl. G08B 1/08; H04Q 7/00; G08B 23/00

(52) U.S. Cl. 340/539.1; 340/539.17; 340/573.1

(57) ABSTRACT

A tracking system for monitoring cleaning frequency has a home unit mounted where a broom or other cleaning device is stored, at least one track recording device mounted on any normal cleaning or sweeping device, a series of beacons which comprise infra red or radio frequency emitters located throughout an area to be monitored such that they illuminate the area, and a data collection unit for storing sweep track data and producing risk management reports based on the stored data. The track recording device has a receiver for detecting each beacon and storing the identification of the beacon along with a time stamp as the cleaning device is moved through the area. The stored information is transmitted to the home unit each time the cleaning device is returned to the storage area, and the cleaning history is provided to the data collection unit.

This application claims the benefit of U.S. Provisional Patent Application Ser. No. 60/687,066, filed Jun. 2, 2005.

### FIELD OF THE INVENTION

The present invention pertains to systems and methods for tracking the movement of a device along a path. More particularly, the present invention pertains to tracking systems that employ a plurality of beacons at selected locations in an environment. The present invention is particularly, but not exclusively, useful as a system and method for creating a record of the movement of a device through an environment, wherein the record includes data pertaining to the time and location of an interaction between the device and various beacons in the environment.

### BACKGROUND OF THE INVENTION

The present invention relates generally to tracking systems and methods for recording movement through an area when performing activities such as cleaning, shopping or the like, and is particularly concerned with a system for keeping records of the frequency of clean up activities in areas frequented by members of the public, such as grocery and other types of stores, shopping malls, and the like.

Retailers, including grocers, mass merchants, home and hardware and others, are frequently the object of slip and fall claims. Some claims are legitimate, and caused by hazards or spills in the retail store. A significant number of claims may also be fabricated in an attempt to extract money settlements from the “deep pocket” retail company.

To manage the slip and fall risk, retailers have historically sought to clear hazardous conditions by regularly “sweeping” store aisles, sometimes hourly, or on other pre-determined schedules. The sweep event was then recorded on a paper log, accompanied by the sweeper's initials and the time the sweep was conducted. The logs were saved and stored at considerable expense, and in the event of a claim, were recovered and used to demonstrate “reasonable care” in the effort to ensure a safe store environment and the absence of hazardous conditions. Reasonable care was then the standard for an appropriate defense against a slip and fall claim.

The paper sweep log system is flawed in several respects. First, the “sweeper” often forgets to initial the log, or he fails to make the sweep, but nonetheless, signs and dates the log in the hope that he will not be found out. In the event of a claim and trial at some future date, it is often relatively easy for plaintiff's counsel to defeat the store's claim of reasonable care by getting the sweeper to admit that he did in fact, from time to time, make a false entry in the log.

There are some electronic sweep recording systems in use, but these are subject to some disadvantages. Such systems generally require some degree of manual intervention to enter information in a hand-held computer, or to touch RFID buttons or bar codes, which activities do not allow the employee to continue normal productive functions. Some systems simply record the location of store personnel by identifying an ID badge worn by such individuals. This does not necessarily indicate that the identified individual was actually carrying out a cleaning activity.

### SUMMARY OF THE INVENTION

It is an object of the present invention to provide a new and improved tracking system and method for automatic recording of movement through a store or public area, for example, to monitor a “sweep” or cleaning process through a store or other public area, or alternatively, customer movement patterns in a store. Additionally, the present invention can be used in other environments, such as hospitals or hospitality environments.

In accordance with the present invention, a system for recording the occurrence of events in a defined environment includes a plurality of beacons that are strategically located in the environment. Specifically, each beacon in the system is positioned and oriented to radiate an electromagnetic beam (e.g. infrared or radio frequency radiation) into its own separate and distinct region of the environment. In some applications it may be preferable for the beam to be directional in order to cover (i.e. “illuminate”) a confined portion of the environment. On the other hand, some applications may be best accomplished using beacons with omni-directional beams that have a broader area of coverage. For purposes of the present invention, individual beacons can be relocated and reoriented, as desired, to obtain the desired coverage in the environment.

Defining an environment and the regions within the environment will vary from system to system. For example, if the environment is a commercial facility (e.g. a grocery store), a region may be an aisle, a portion of the aisle, or a corner where two or more aisles meet. Further, in like environments, regions may be any area of a store that requires periodic maintenance or cleaning, such as shelves, counter tops or work spaces. In any event, it is important that each beam be specifically associated with an identifiable region, and that each beam include identifying information about its beacon. For example, this identifying information can include the location of the beacon. Additionally, it may include the time and date of beacon operation, and whatever other operational or functional parameters of the beacon that may be of particular importance.

In addition to the plurality of beacons just mentioned, the system of the present invention also requires mobile recording units that can be individually moved through the environment. More specifically, the present invention envisions using recording units that can be individually affixed or attached to a respective carrier (e.g. a person, a broom or a shopping cart). The carrier with the affixed recording unit is then set for movement through the environment on either a predetermined track or a randomly executed track.

For the present invention, as a recording unit is moved through selected regions in the environment, it will interact with the beacons. Specifically, this interaction will be between the recording unit and the particular beam that is being radiated from a beacon into the region where the recording unit is located. An important aspect of the present invention is that whenever the recording unit enters a region, and when it interacts with the beam of a beacon in the region, it will generate an event signal. Importantly, an event signal is indicative of an interaction between the recording unit and the beacon. Further, as received with the beacon's beam, the event signal that is generated in the recording unit will include identifying information about the beacon. During each trip through the environment, a recording unit will generate a different event signal for each region it passes through. Thus, a single recording unit may generate one, or many, event signals per trip.

Also included in the system of the present invention is a base unit that can be electronically engaged with the recording unit(s). With this engagement, the event signals are transferred and stored in the base unit. Further, when transferred to the base unit, each event signal is identified with the particular recording unit that recorded the event signal. At a subsequently convenient time, unless a computer is incorporated into the base unit, the event signals can be transferred to a computer over a wireless communications network (e.g. the internet), or by landline. In any event, when the computer receives the stored event signals from the base unit, it can use the event signals to create a report.

In the operation of the system of the present invention, a recording unit is somehow affixed or attached to a carrier. The combination of carrier and recording unit is then moved through the environment. During this movement, the recording unit will interact with beacons in the system as it (i.e. the recording unit) passes through the various regions of the environment where the beams of beacons are being radiated. With each interaction, the recording unit generates an event signal that documents the passage of the recording unit through the region. After a trip through the environment has been completed, the event signals that have been generated are transferred from the recording unit to a base unit for storage. Subsequently, the event signals can be further transferred to a computer for use in the creation of a report.

According to one aspect of the present invention, a tracking system is provided, which comprises a home base unit, a track recording device (i.e. recording unit) mounted to any normal cleaning or sweep device, or to a shopping cart, a series of beacons which comprise infra red or radio frequency emitters located throughout an area to be monitored such that they illuminate the area, and a data collection device for storing track data of the path of a cleaning device or of a shopping cart through a store.

In one embodiment of the invention, the system is used to monitor a sweep or cleaning process which is carried out at periodic intervals. In this case, the home base unit is mounted where brooms or other cleaning devices are stored when not in use. The home base unit is RF enabled and has a receiver for receiving time-date-location data from the track recording device that accompanies the sweep or cleaning device. The home base unit also has a memory for storing data and a transmitter for sending the data out via a wired or wireless link via a network to the data collection device. The home unit may be capable of receiving sweep data from the sweep track device via wired connection, RF or IR. The data collection device may be a local computer, PDA, or a remotely located central data collection unit accessed via the Internet.

The track recording device is affixed to any normal cleaning or sweep device such as a broom that is used to physically sweep the aisles on a routine, scheduled basis, to ensure there are no hazardous conditions present, and to clean up any hazards encountered. The cleaning device may be a mop, broom, vacuum cleaner or the like, and the track recording devices may be secured to a plurality of different cleaning devices if desired. The track recording device has a receiver for receiving RF or IR signals from small, inexpensive, battery powered devices or beacons positioned throughout the store on the designated sweep path, a processor for receiving and storing the signals, and a transmitter for transmitting the stored signals to the home unit when the cleaning device is returned to storage after completion of the scheduled cleaning. The small RF or IR beacons emit a local signal on a regular basis, including the unique ID and location of each beacon. The track recording device on the cleaning device thus records its passage past individual beacons and stores the data from one or more such sweeps. When the broom or cleaning device is returned to the vicinity of the home unit, the data is communicated either physically or wirelessly to the home unit, and transmitted out through the network.

The positioning beacons are small, low power, short range, battery powered, IR or RF devices located throughout the store along the sweep track. The beacons may be directed towards the floor to illuminate a predetermined area, or may be mounted close to the floor to emit a signal in a direction along the floor. Each of these beacons radiates a signal with a unique ID, at predetermined, short intervals. As the sweep device and track recorder pass through each beacon zone, the passage is recorded in sequence and downloaded when the track recording device is returned back to the location or vicinity of the home base unit.

The data storage device comprises a computer with storage capacity and software to store the sweep track data (i.e. event signals) and to produce such risk management reports that may be desired, as well as sweep track reports covering the date and time of a slip and fall claim.

The system may alternatively, or additionally, be used to monitor consumer behavior in a store, or the pattern of movement of customers through the store. Such data may be used, for example, to determine the effectiveness of a store display or advertising campaign on a regular basis. In this case, tracking devices or tags are mounted on selected shopping carts and baskets. The tracking devices receive signals from the beams emitted by beacons, and transmit the beacon ID and time stamp data via RF or the like to the home unit. The home unit then accumulates data on customer traffic through the store and the locations most frequently visited by customers, and can be programmed to create various types of reports. For example, such reports may be used to change advertising or displays if they are seen to be ineffective.

According to another aspect of the present invention, a method of tracking periodic sweeping or other cleaning of a predetermined area is provided, which comprises the steps of:

attaching a tracking device to one or more cleaning tools;

positioning a plurality of beacons at spaced locations throughout an area to be cleaned, each beacon emitting a signal with a unique ID for identifying the beacon location at short, predetermined intervals;

moving the cleaning tool through the area to be cleaned so that the signal emitted from each beacon is detected by the tracking device and the beacon ID and time of detection is stored by the tracking device; and

after completion of a cleaning procedure, returning the cleaning tool to a predetermined storage area and transmitting the stored data from the tracking device to a home unit to provide a record of the cleaning or sweep track through the area to be cleaned.

This invention provides a wireless electronic system that automatically records the sweep or periodic cleaning process with a precise, digital, date-time-location record of the sweep track through the store. The digital record can then be backed up and stored very efficiently, and recalled readily in the event of a claim. The digital record is not subject to human error or fraudulent entry, and only records what is done. The system can alternatively be used to track consumer movement patterns in a store on a regular basis.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 is a schematic diagram of a tracking system according to an exemplary embodiment of the invention;

FIG. 2 is a schematic diagram of the home base unit of FIG. 1;

FIG. 3 is a side elevation view of a produce display unit indicating an exemplary beacon location and direction of the beam emitted by the beacon;

FIG. 4 is a schematic representation of an exemplary “cleaning device” as well as a suitable track recording device for attachment to the handle of the “cleaning device”;

FIG. 5 is a schematic diagram of the beacon of FIG. 1; and

FIG. 6 is a plan view illustrating an example of an area (environment) to be cleaned in a grocery store as well as exemplary beacon positions for tracking the path of a cleaning device (carrier/recording unit) through the area.

### DESCRIPTION OF THE PREFERRED EMBODIMENTS

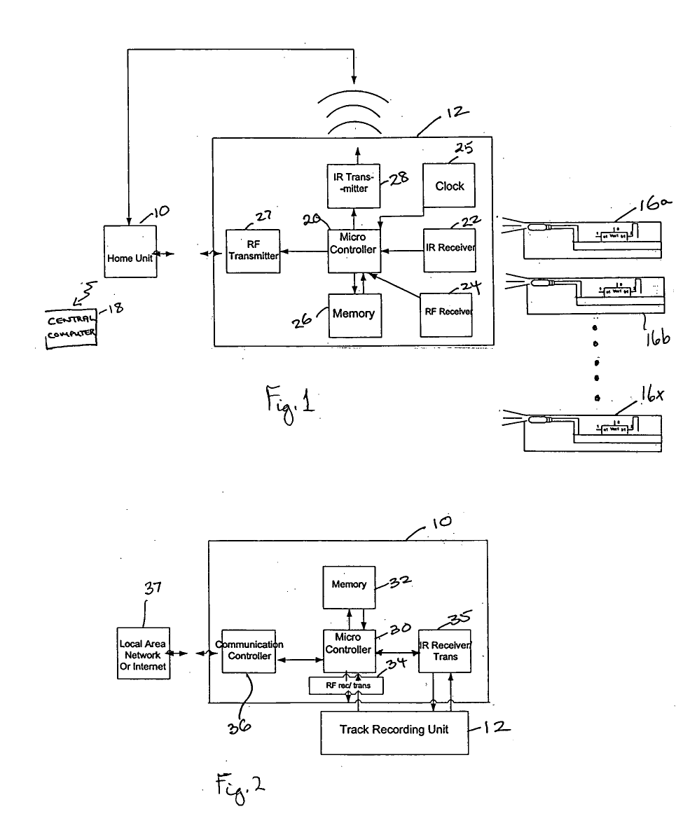

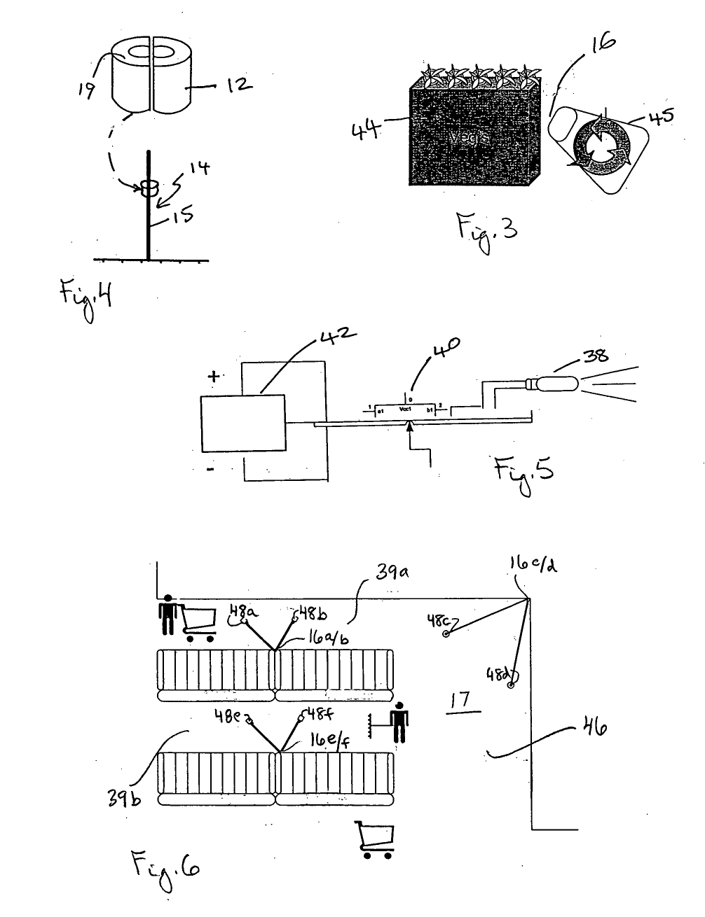

The drawings illustrate a tracking system and method according to an exemplary embodiment of the invention for tracking and recording successive cleaning procedures in a predetermined area, such as a grocery store or the like. The basic components of the system are illustrated in FIG. 1, and comprise a home base unit 10 which will be mounted conveniently wherever a carrier 15, such as a broom, mop, vacuum cleaner, or other cleaning device is normally stored, a track recording unit 12 for mounting on any normal cleaning or sweep device, for example on the handle 14 of a broom 15 or the like (see FIG. 4), a plurality of positioning beacons 16 located at spaced intervals throughout an area to be monitored (i.e. an environment 17: see FIG. 6), and a central computer 18 with software and memory to store sweeping or cleaning track data and to create various reports (not shown). The computer 18 may be located in the store and may be part of the home base unit 12 or it may be a separate unit or a remote computer for storing information from various different facilities.

Still referring to FIG. 1, it is to be appreciated that the track recording unit 12 is mounted at an appropriate location on any normal cleaning or sweeping device, such as a broom 15, a mop, a vacuum cleaner, or the like. The components of unit 12 may be mounted in a clamshell-like housing 19 (see FIG. 4) for clamping around the handle 14 of the cleaning implement. Alternatively, it may be mounted in a simple box like housing for attachment to a cleaner housing, e.g. a vacuum cleaner, by fastener screws or the like. For some applications, the track recording unit 12 may be mounted on the cleaning device at a location fairly close to the ground engaging end of the device.

As shown in FIG. 1, the components of the track recording unit 12 are a microcontroller or processor unit 20, an infra red receiver 22 or an RF receiver 24 (depending on the nature of beacons 16) linked to microcontroller 20, a clock or timer 25 linked to the microcontroller 20, a memory 26, and an RF transmitter 27 or infra red transmitter 28 for transmitting information stored during a cleaning procedure to the home unit 10.

As illustrated in FIG. 2, the home base unit 10 comprises a microcomputer or processor unit 30, as well as a memory 32, an RF transmitter/receiver 34 or IR transmitter/receiver 35, and a communication controller 36 for sending data via a wired or wireless link to a local area network or via the Internet 37 to a central computer or data processing unit 18. The unit 10 is capable of receiving cleaning or sweep data from the track recording unit via a wired connection, or via RF or IR signal transmission as indicated in FIG. 2.

The beacons 16 are each small, low power, short range IR or RF emitters which will be mounted throughout an area to be monitored. The beacons 16a, 16b and 16x shown in FIG. 1 are only exemplary. For example, if the area is a store, the beacons 16 will be mounted to illuminate all store aisles (e.g. aisles 39a and 39b shown in FIG. 6). As illustrated in FIG. 5, each beacon 16 has an IR or RF source 38 with a unique ID or identifier, a microcontroller 40 for controlling operation of the source 38, and either a battery or wall socket input 42 for providing power to the beacon unit. The microcontroller 40 is programmed to drive the IR or RF source to emit a beacon with a unique ID at intervals of one second or so, i.e. often enough to illuminate a passing track recording device 12. Each beacon may be directed towards the adjacent floor area, as indicated in FIG. 3. In FIG. 3, the beacon unit 16 is mounted on a side wall of a store display unit 44, and emits a narrow, cone-shaped beacon or beam 45 which is aimed down to limit the exposed area.

FIG. 6 illustrates a possible arrangement of beacons 16 a-f to illuminate respective regions 48a-f in the aisles 39a, 39b and 46 of a store area between adjacent produce shelves or displays 44.

Operation of the tracking system will now be described in more detail. Store personnel assigned to clean store aisles 46 on a regular basis will retrieve a carrier 15 (i.e. a cleaning device), such as a broom or the like, from the storage area adjacent the home base unit 10. The tracking device 12 will be mounted on the carrier 15 cleaning device, ensuring that, whenever someone goes out to clean or inspect the monitored area, i.e. environment 17, they must take the tracking device with them.

As the carrier 15, cleaning device, or “broom” is moved through the monitored area, environment 17, (see FIG. 6), the recording unit 12 will receive signals from all the beacons it passes, and will record the ID of each tracker signal along with a time stamp as an event signal. The information is stored in memory 26, which will therefore contain a continuous record of the sequence of locations (i.e. regions 48) in the area of environment 17 that is visited by the cleaning device (carrier 15) that is carrying the recording unit 12. When the unit 12 is returned to the storage area containing the home base unit, the two devices will communicate via a wired connection, infra-red, or radio frequency signals. At this time, the tracker recording unit 12 will transmit the contents of memory 26 to the home base unit 10 via RF transmitter 27, IR transmitter 28, or a wired connection (not illustrated). The tracker recording unit 12 is programmed to selectively look for a home base unit 10, and when the home base unit 10 is located, the track recording unit 12 will automatically upload the contents of its memory (beacon id's and associated time stamps) to the home base unit 10. Home base unit 10 will then send the cleaning data via a wired connection, the local network, or via the Internet 37 to any network or data collection device, such as a remotely located central computer 18 or a PDA, where it can be stored and analyzed. This procedure is repeated each time the cleaning device (i.e. carrier 15 and recording unit 12) are used, so that a continuous historic record of the cleaning of the monitored area is kept.

The central computer 18 may be programmed to store the sweep or cleaning track data, and to produce such risk management reports as might be desired, as well as sweep track reports covering the time of a slip and fall claim.

The home base unit 10 may be outfitted with the ability to produce output information via LEDs or other output devices, to indicate a range of performance indicating measures, such as actual sweep or cleaning frequency as compared with policy sweep frequency, the largest time gap between cleaning sessions, beacons or zones missed during a sweep, and a sweep score, or indication that all zones or a designated number or percentage of zones were swept. This will provide useful feedback to personnel and supervisors and provide motivation to clean the monitored area thoroughly. The home base unit 10 may also provide a “bonus score” comprising a numerical indication of compliance or non-compliance with company sweep policy and potential qualification for a monetary bonus or other reward.

The track recording unit 12 may be programmed to beep if one or more beacons 16 are missed, or beep as each beacon 16 is “seen”. As noted above, the system includes a plurality of beacon units 16, with the number of units dependent on the extent of the area environment 17 to be monitored. Additionally, one or more track recording units 12 may be provided, particularly where more than one cleaning device (i.e. carrier 15) or type of cleaning device is used to clean the area. Each cleaning device will have a particular track recording unit 12 attached, and each track recording unit 12 will then have its own specific identification code which will be transmitted to the home unit as part of the cleaning data transmission.

This invention provides a wireless electronic system that automatically records the sweep or cleaning process with a precise, digital, date-time-location record of the sweep track through the store or other area to be maintained. The digital record can then be backed up and stored very efficiently, and recalled readily in the event of a claim. The digital record is not subject to human error or fraudulent entry, and only records what is done.

The proposed system is superior to the paper sweep log system because it is not subject to inadvertent omissions or false entries and requires no manual entry and no paper filing. It is also superior to other current electronic sweep recording systems, insofar as these generally require some level of manual intervention to enter information in a hand held computer, or touch RFID buttons or bar codes, which activities do not allow the sweep employee to continue normal productive functions. The proposed system is also superior in that it can be configured to provide immediate, automatic feedback of sweep performance in comparison to corporate risk management sweep policy. This feedback capability will reduce the requirement for store management to actively manage the sweep process, while at the same time, increasing risk management behavior and compliance.

Although the system and method described above is used to monitor cleaning activity in a selected area (environment 17), such as a store, it may alternatively be used for other monitoring purposes, such as tracking the movements of customers in a store. Such information is useful in determining the effectiveness of product displays and advertising campaigns. In this embodiment of the invention, tracking devices or tags will be mounted on shopping carts and baskets, and will receive beacon signals as the customer passes beacon locations in the store. The received beacon ID information will then be eventually transmitted, along with the time stamp, to an appropriately positioned home base unit 10. The data may be collected in the home base unit 10, which may incorporate a computer 18 for generating various types of report of traffic patterns in the store, or may be transmitted to a remote central processing station for further processing, as in the previous embodiment.

The advantage of the system when used to monitor customer traffic is that it provides consumer behavior information without requiring collection of personal records of individual consumer shopping information. At the same time, it can provide valuable information on the effectiveness of a store display or advertising campaign. The customer traffic monitoring system may be used in conjunction with a cleaning monitoring system, simply by incorporating tracking devices on both carts and cleaning devices, and utilizing the same beacons and home base unit to store both customer movement and cleaning data.

Although an exemplary embodiment of the invention has been described above by way of example only, it will be understood by those skilled in the field that modifications may be made to the disclosed embodiment without departing from the scope of the invention.

While the particular Tracking System and Method as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for recording the occurrence of events in a defined environment which comprises:
a plurality of beacons, wherein each beacon is positioned and oriented to radiate a beam into a region of the environment, and wherein each beam includes identifying information about its beacon;
a recording unit, wherein the recording unit is moveable through selected regions in the environment to interact with the beam being radiated from a particular beacon into the respective region, and to generate an event signal indicative of each interaction, and wherein the event signal includes the identifying information about the beacon and an identification of the recording unit; and
a base unit for storing the event signals.

2. A system as recited in claim 1 wherein the identifying information includes the position of the particular beacon and a time of the interaction between the recording unit and the beam from the beacon.

3. A system as recited in claim 1 wherein the beam is selected from a group of electromagnetic radiations consisting of infrared radiation (IR) and radio frequency radiation (RF).

4. A system as recited in claim 1 further comprising means for shaping the beam as a directional beam.

5. A system as recited in claim 1 further comprising a means for selectively reorienting each beacon to redirect its beam and alter the region wherein the respective beam is radiated.

6. A system as recited in claim 1 further comprising a computer for receiving the stored event signals from the base unit and for creating a report therewith.

7. A system as recited in claim 1 further comprising a carrier, wherein the recording unit is mounted on the carrier for movement through the environment.

8. A system as recited in claim 7 wherein the environment is a commercial facility.

9. A system as recited in claim 8 wherein the carrier is a broom.

10. A system for recording the occurrence of events in a defined environment which comprises:
a means for radiating a plurality of separate electromagnetic beams into respective regions of the environment, wherein each beam includes identifying information;
a means for recording the identifying information as an event signal whenever the recording means is moved into a region and interacts with a beam of the radiating means in the region, wherein the identifying information in the event signal includes information about the particular beam and the time of interaction, between the beam and the recording means; and
a means for storing a plurality of event signals for use in creating a report.

11. A system as recited in claim 10 wherein the radiating means is a plurality of beacons, wherein each beacon is positioned and oriented to radiate a beam into a selected region of the environment.

12. A system as recited in claim 10 wherein the recording means is a unit capable of recording a plurality of separate and different event signals.

13. A system as recited in claim 12 wherein the storing means is a base unit for receiving and storing the plurality of event signals when the recording means is electronically engaged with the storing means, and wherein the system further comprises a computer for receiving the stored event signals from the base unit to create a report therewith.

14. A system as recited in claim 10 wherein the beams are selected from a group of electromagnetic radiations consisting of infrared radiation (IR) and radio frequency radiation (RF).

15. A system as recited in claim 10 further comprising a carrier, wherein the recording means is mounted on the carrier for movement through the environment.

16. A system as recited in claim 15 wherein the environment is a commercial facility and the carrier is a broom.

17. A method for recording the occurrence of events in a defined environment which comprises the steps of:
radiating a plurality of separate electromagnetic beams into respective regions of the environment, wherein each beam includes identifying information;
moving a recording unit into a region of the environment to interact with a beam;
receiving the identifying information from the beam to generate an event signal, wherein the identifying information includes information about the particular beam and the time of interaction between the beam and the recording unit;
recording the event signal;
storing a plurality of event signals; and
creating a report with the plurality of event signals.

18. A method as recited in claim 17 wherein the storing step further comprises the step of engaging the recording unit with a base unit, wherein the base unit temporarily stores the event signals.

19. A method as recited in claim 18 further comprising the step of transferring the event signals to a computer to accomplish the creating step.

20. A method as recited in claim 19 further comprising the step of selecting the beams from a group of electromagnetic radiations consisting of infrared radiation (IR) and radio frequency radiation (RF).
